(19) United States
(12) Patent Application Publication
(10) Pub. No.: US 2007/0275840 A1
(43) Pub. Date: Nov. 29, 2007

(54) Non-Euclidian Three-Dimensional Objects and Methods of Forming the Same

(76) Inventor: Herbert G. Bennett, Brooklyn, NY (US)

Correspondence Address: MORRISON & FOERSTER LLP, 1650 TYSONS BOULEVARD, SUITE 400, MCLEAN, VA, 22102, US

(21) Appl. No.: 10/573,657

(22) PCT Filed: Sep. 30, 2003
(86) PCT No.: PCT/US03/31231

§ 371 Date: Mar. 16, 2007

(51) Int. Cl. B31B 49/00

(52) U.S. Cl. 493/342; 493/1

(57) ABSTRACT

A method of forming a three-dimensional object having a base region and a plurality of curved sidewalls is disclosed (FIGS. 5-8). The object is formed from a two-dimensional piece of material that has been inscribed with geometrical information to form a template. The template comprises a base region and a sidewall region or regions. The sidewall regions are manipulated using a variety of methods to allow the template to be folded into the three-dimensional object (FIGS. 21-25).

### FIELD OF INVENTION

This invention relates to the field of creating three dimensional objects. This invention also relates to the use of non-Euclidean geometry to create useful objects with a pleasing aesthetic appearance.

### BACKGROUND OF THE INVENTION

The prior art discloses numerous methods for the formation of three dimensional objects from pieces of two-dimensional material which are useful in a variety of applications. Generally, these objects are formed by initially producing a blank or element from the piece of two dimensional material, which is then folded, bent, or otherwise manipulated to conform to the shape of a three dimensional object.

The bulk of the prior art in this regard shows elements having substantially straight lines upon which the edges of the three dimensional objects are folded. In other words, most of the prior art is formed using Euclidean geometrical forms and principles. Euclidean geometry is characterized by the use of straight lines to connect points in space.

It is often desirable, however, to produce and utilize objects with curved or arced faces, lines, or edges rather than straight lines. This is also known as non-Euclidean geometry, relying upon curved lines to connect points in space as opposed to the straight lines used in Euclidean forms. The use of non-Euclidean geometry creates an appearance that is aesthetically pleasing and is a welcome contrast to strict Euclidean forms.

Example of the aesthetically pleasing appearance of such curved sides of an object may be found in U.S. Pat. No. 5,364,017. This patent teaches the use of a method to create a blank from a flat piece of material that can be formed into three-dimensional containers that are held together by the tensions created in the material as a result of the curved folds made in the material. However, this patent only teaches the use of inwardly curved circular arcs, all of the same radius of curvature, to define the lines along which the material may be folded. This limits the types of new objects that may be formed with varying dimensions, proportions, and elements. Furthermore, such designs are limited to closed shapes formed from the combination of inwardly curved arcs alone.

It may be possible for one skilled in the art to create a blank from two-dimensional material that may be folded into a three-dimensional object using arcs and curves by randomly drawing lines on the material. However, this unstructured approach does not allow the resulting pattern to be easily reproduced, particularly by those with limited or no artistic training and/or ability. Furthermore, there is also an inherent aesthetic quality that comes from an object that is formed along structured and systematic principles.

Therefore, there is a need for a structured and repeatable method of creating a new and different form for an open three-dimensional object from a two-dimensional flat piece of material by utilizing a number of outwardly curved arcs as edges or sides to form an aesthetically pleasing object, such objects comprising outwardly curved edges and surfaces.

### SUMMARY OF THE INVENTION

The invention is directed to a method for forming or creating three dimensional objects from two-dimensional material, and preparing two-dimensional templates for creating such objects, comprising outwardly curved edges and surfaces. Preferably, the material may be any substantially flat piece of material.

The present invention allows a user to create three-dimensional objects with non-Euclidean elements from two dimensional material in a systematic way that can be easily reproduced. Euclidean, or “straight line” concepts may also incorporated into such objects.

In a preferred embodiment, a method of preparing a template capable of forming a three-dimensional object from two-dimensional material comprises the steps of: (1) inscribing a first outer arc on a surface of the material, the first outer arc having a first radius of curvature and a first endpoint; (2) inscribing a second outer arc, the second outer arc having a radius of curvature equal to the first radius of curvature, wherein the center of the second outer arc is at the first endpoint, and the second outer arc intersects the first outer arc to form a first outer vertex; (3) inscribing a third outer arc having a third radius of curvature equal to the first radius of curvature and having its center at the first vertex, wherein the third outer arc intersects the first outer arc and the second outer arc to form a second outer vertex and a third outer vertex; (4) inscribing three inner arcs, the inner arcs each having a radius of curvature equal to each other but less than the first radius, wherein each of the three inner arcs intersect with each other to form first, second, and third inner vertices; and (5) separating the material inscribed by the first, second, and third outer arcs to form a template. Each of the inner arcs may be parallel to at least one of the first, second, or third outer arcs. The material between the outer arcs and the inner arcs defines a sidewall region and corner regions, which may be subsequently manipulated and folded to form a three-dimensional object.

In another preferred embodiment, a method of forming a three-dimensional object from a piece of two-dimensional material comprises the steps of: (1) inscribing an outer perimeter on a surface of the material comprising at least three intersecting outer arcs, the outer arcs defining an interior, the at least three outer arcs curving outwardly from the interior; (2) inscribing a inner perimeter within the outer perimeter, the inner perimeter defining a base region therein, and the outer perimeter and the inner perimeter defining at least three sidewall regions therebetween; (3) adding additional geometric information to the sidewall region; and (4) manipulating the sidewall region to form a three-dimensional object with a plurality of sidewalls. The additional geometric information may be added by adding reference indicators to the surface of the material, then using the reference indicators to define a plurality of reference points, which may be used to inscribe additional lines into the material.

In another preferred embodiment, a three-dimensional object comprising a base and a plurality of sidewalls is formed by a method comprising the steps of: (1) inscribing a first arc on a surface of a two-dimensional material, the first arc having a first radius of curvature and a first endpoint; (2) inscribing a second arc, the second arc having a radius of curvature equal to the first radius of curvature, wherein the center of the second arc is at the first endpoint, and the second arc intersects the first arc to form a first outer vertex; (3) inscribing a third arc having a third radius of curvature equal to the first radius of curvature and having its center at the first vertex, wherein the third arc intersects the first arc and the second arc to form a second outer vertex and a third outer vertex; (4) inscribing three inner arcs, the inner arcs each having a radius of curvature equal to each other but less than the first radius, wherein each of the three inner arcs intersect with each other to form first, second, and third inner vertices; (5) separating the material inscribed by the first, second, and third outer arcs to form a template; and (5) manipulating the material of the template within the sidewall region, and folding the material along at least one of the first, second or third inner arcs to form a three-dimensional object.

In yet another preferred embodiment, a non-Euclidean three-dimensional object suitable for use as a plate or bowl comprises a substantially flat base defining a base plane and comprising three outwardly curving base arcs, with the base arcs intersecting each other to form three base vertices. Three substantially flat sidewalls are attached to the base, each sidewall projecting upwardly at an angle to the base plane, with each sidewall comprising at least one outwardly curving sidewall arc to form a top sidewall edge, and each sidewall arc being spaced apart from and parallel to at least one of the base arcs. Three corner edges connect the sidewalls, with each corner edge originating at the base vertices and projecting upwardly at an angle to the base plane, and the sidewalls are joined together to each other at the corner edges, whereby the base and sidewalls form a three-dimensional plate or bowl capable of holding food.

### BRIEF DESCRIPTION OF THE DRAWINGS

FIG. 1 is an illustration of an arc formed by an embodiment of the present invention to create the three-dimensional objects.

FIG. 2 is an illustration of two arcs formed by an embodiment of the present invention.

FIG. 3 is an illustration of an exploded non-Euclidean triangle formed by an embodiment of the present invention.

FIG. 4 is an illustration of a first preliminary template in accordance with the present invention.

FIG. 5 is an illustration of a second preliminary template in accordance with the present invention.

FIG. 6 is an illustration of a third preliminary template in accordance with the present invention.

FIG. 7 is an illustration of a preliminary template in accordance with the present invention with reference lines shown in dashed lines.

FIG. 8 is an illustration of a preliminary template showing edge lines in accordance with the present invention.

FIG. 9 is an illustration of a completed template with corner material removed in accordance with the present invention.

FIG. 10 is a top elevation view of the three-dimensional object formed from the completed template of FIG. 9.

FIG. 11 is a side elevation view of the three-dimensional object of FIG. 10.

FIG. 12 is a fourth preliminary template.

FIG. 13 is a side cross-sectional view of the object formed from the template of FIG. 12.

FIG. 14 is a fifth preliminary template.

FIG. 15 is a side cross-sectional view of the object formed from the template of FIG. 14.

FIG. 16 is a top elevation view of another template formed in accordance with the present invention.

FIG. 17 is a top elevation view of an object formed from the template of FIG. 16.

FIG. 18 is a side elevation view of the object of FIG. 17.

FIG. 19 is a top elevation view of another template formed in accordance with the present invention.

FIG. 20 shows several lines defined by mathematical functions that may be used with the present invention.

FIG. 21 is a top elevation view of another template formed in accordance with the present invention.

FIG. 22 is a top elevation view of an object formed from the template of FIG. 21.

FIG. 23 is a perspective view of the object of FIG. 10.

FIG. 24 is a perspective view of the object of FIG. 14.

FIG. 25 is a top elevation view of another template formed in accordance with the present invention.

FIG. 26 is a top elevation view of an object formed from the template of FIG. 25.

FIG. 27 is a side elevation view of the object of FIG. 27.

FIG. 28 is a top elevation view of another template formed in accordance with the present invention.

FIG. 29 is a top elevation view of another template formed in accordance with the present invention.

### DESCRIPTION OF THE PREFERRED EMBODIMENTS

The present invention provides a method of preparing a template capable of forming a three-dimensional object from two-dimensional material in a manner which preferably provides a “folded” look to the object. It can be appreciated by one skilled in the art that the novel three-dimensional objects of the present invention can be formed from a variety of materials. Materials used to form the objects are preferably flexible at some temperature (i.e. room temperature or elevated), but capable of retaining a bend or fold. For example, the object may be formed from paper, cardboard, plastic, metal, wood, rubber, elastomers, ceramics, or any other similar material capable of retaining a bend or fold. However, the material may be inflexible, but capable of being cut into various segments that may be joined and/or rejoined by suitable means known in the art.

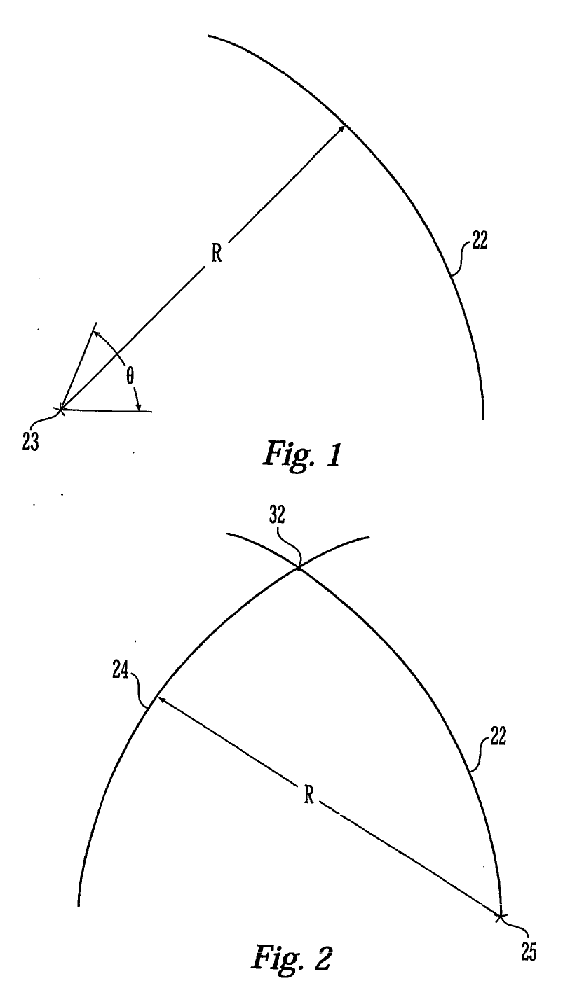

As illustrated in FIG. 1, in a first embodiment, first outer arc 22, with a radius of curvature R, is inscribed. First outer arc 22 has center 23 and is preferably inscribed over an angle θ greater than 60 degrees. Next, as illustrated in FIG. 2, second outer arc 24 is inscribed so that second outer arc 24, also preferably having the same radius of curvature R, intersects with first outer arc 22, forming first vertex 32. The center of second outer arc 24 lies along first outer arc 22, preferably near one of first outer arc's 22 ends. In a preferred embodiment, the center of second outer arc 24 is at endpoint 25 of first outer arc 22.

First vertex 32 in turn may be the center of third outer arc 26, which is illustrated in FIG. 3. Third outer arc 26 preferably also has the same radius of curvature R and intersects first outer arc 22 and second outer arc 24. Second vertex 34 and third vertex 36 are defined by the intersections of third outer arc 26 and first outer arc 22 and second outer arc 24 respectively. First outer arc 22, second outer arc 24, and third outer arc 26 cumulatively define a first exploded non-Euclidean triangle 28 with, outer arcs 20 that may form the outer edge of object 10 (see, e.g., FIG. 10). First, second, and third vertices 32, 34, and 36 cumulatively define outer vertices 30 of first exploded non-Euclidean triangle 28. For illustration purposes, perimeter lines 5 have been shown to illustrate the base geometric pattern (i.e., a Euclidean equilateral triangle) that connects vertices 30. As used herein, an “exploded” element is one with arcs that curve or expand outwardly from the center or interior of an element about Euclidean perimeter line 5. Thus, outer arcs 20 may be described as exploding arcs. Conversely, an “imploded” element is one with arcs that curve or contract inwardly towards the center or interior of an element about Euclidean perimeter line 5 (e.g. opposite of arc 24 shown in FIG. 3).

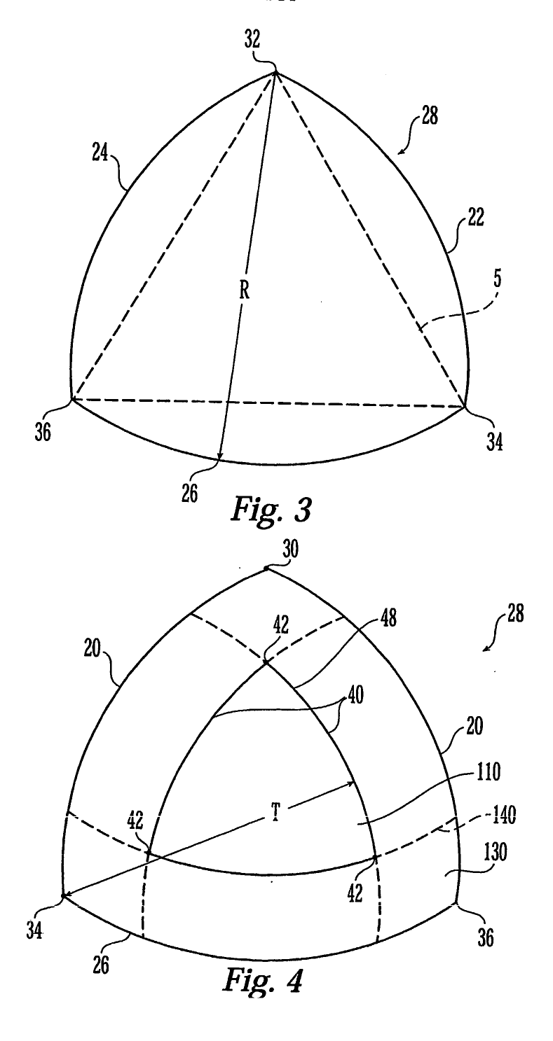

Next, as illustrated in FIG. 4, inner arcs 40 are inscribed within triangle 28 in a manner similar to that described above, each inner arc 40 having a radius of curvature T that is less than R. Inner arcs 40 thus define a second exploded non-Euclidean triangle 48 within the interior of first triangle 28, with inner vertices 42. In one embodiment as shown, it can readily be seen that each inner arc 40 is preferably “parallel” to an outer arc 20; i.e., the shortest distance between outer arcs 20 and inner arc 40 is always the same at any point along the arcs, equal to the difference between R and T.

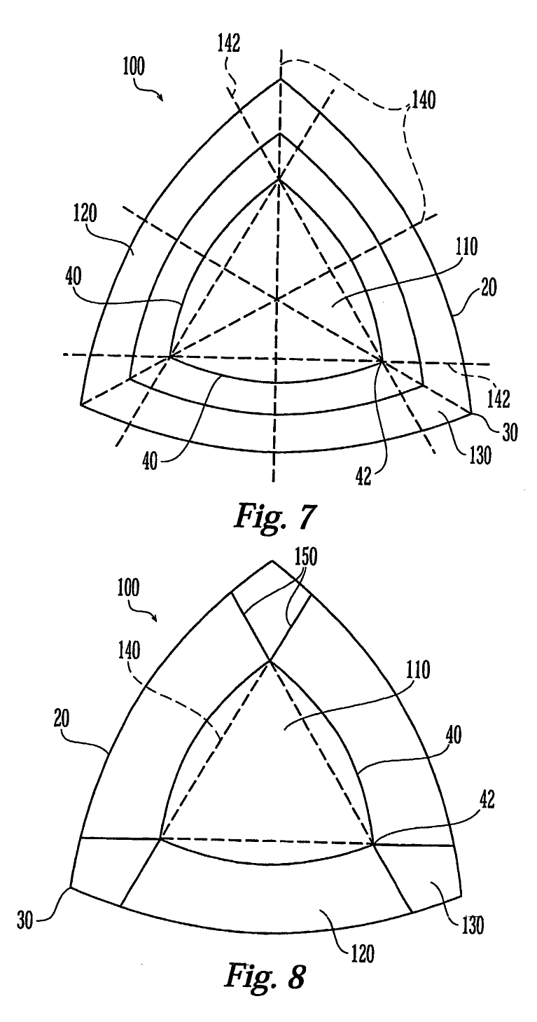

The form illustrated in FIG. 4 and FIG. 7 is defined as preliminary template 100. From this basic form, additional “geometric information,” for example, in the form of inscribed lines or geometric shapes, may be added to template 100 to allow it to be formed into object 10. The area enclosed within the inner arcs 40 may be defined as base region 110. The area between the outer arcs 20 and the inner arcs 40 may be defined as sidewall region 120. Sidewall region 120 may be used to form sidewalls 170 of the three-dimensional object, as further described below. Of the sidewall regions 120, the areas near vertices 30 are defined as corner regions 130. In a preferred embodiment, corner regions may be defined as the area bounded by the outer arcs 20 and reference lines 140 that are continuations of inner arcs 40 (see shaded region of FIG. 4). However, in other embodiments, corner regions 130 are not defined by these lines and may encompass more or less of sidewall region 120. In order to form a three-dimensional object 10 from preliminary template 100, the material in corner regions 130 may be manipulated, as further described below.

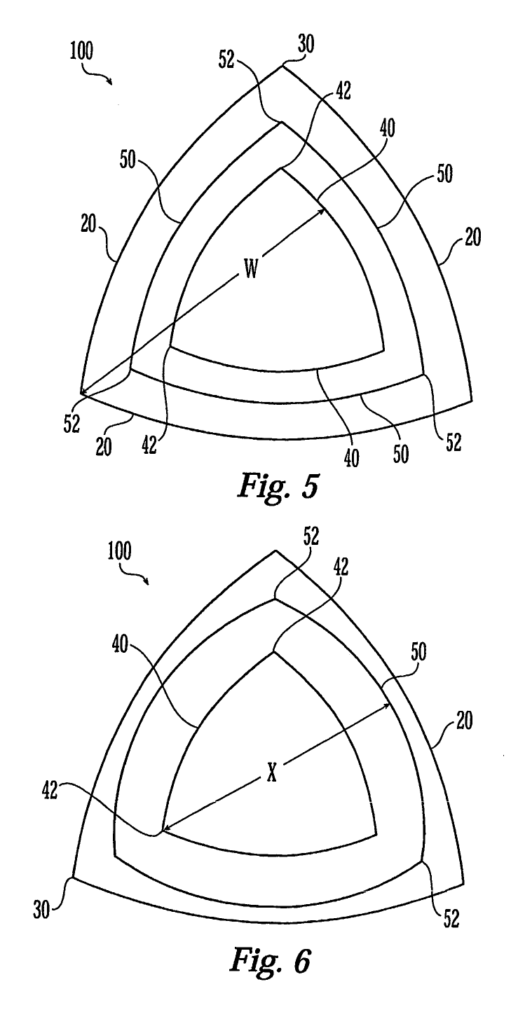

Geometric information may be added to sidewall region 120 by inscribing additional arcs into template 100 using vertices 30, 42 as reference points. As illustrated in FIG. 5, third arcs 50 are inscribed into sidewall region 120. The intersections of third arcs 50 define vertices 52. Each third arc 50 has a radius of curvature W that is less than radius of curvature R, but greater than radius of curvature T with its center at one of outer vertices 30. In this template 100, third arcs 50 are parallel to outer arcs 30 and inner arcs 40. In contrast, template 100 illustrated in FIG. 6 has third arcs 50 with radii of curvature X that are formed by placing the centers of third arcs 50 at inner vertices 42. As a result, third arcs 50, while being between outer arcs 20 and inner arcs 40, are not parallel to outer arcs 20 and inner arcs 40.

Accordingly, it is apparent that changing the locations of the centers of inner arcs 40 and third arcs 50 creates numerous possibilities for making various shapes from which three-dimensional objects may be formed. In addition, locating the centers of at least some of inner arcs 40 on outer arcs 20 between vertices 30 creates other possible shapes. Similarly, the centers of at least some of third arcs 50 may be located between the vertices 30 of outer arcs 20 or between inner vertices 42 of inner arcs 40. The foregoing variations allows for various non-symmetrical three-dimensional objects to be created having arcs of different lengths and orientations.

As illustrated in FIG. 7, vertices 30, 42 may also be used to define reference lines 140, to further define reference points from which additional geometric information may be added to preliminary template 100. For example, in this embodiment, each reference line 140 is defined by pairs comprising an outer vertex 30 and the immediately adjacent inner vertex 42. As another example shower FIG. 7, another set of reference lines 142 is defined by pairs of adjacent inner vertices 40.

One of the advantages of the present invention is made apparent here, in that any pattern may be easily reproducible using a structured method, not only in physical form, but in the form of instructions that may be easily carried out using uncomplicated tools and materials.

The manipulation of the corner regions 130 is described next. In order to allow the material to form sidewalls that may be joined, the material located in the vicinity of the outer vertices is preferably manipulated in some way to allow material within sidewall region 120 to be folded upward. This manipulation may consist of removing material from corner regions 130 in various shapes. Alternatively, the material in corner regions 130 may be bent or folded over itself, or the material in corner regions 130 may be cut and overlapped.

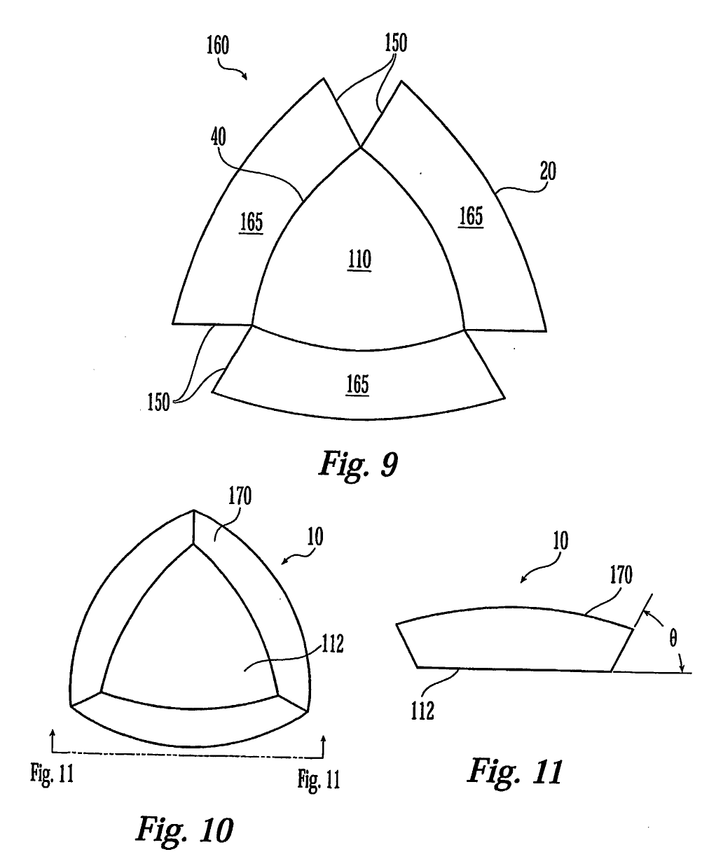

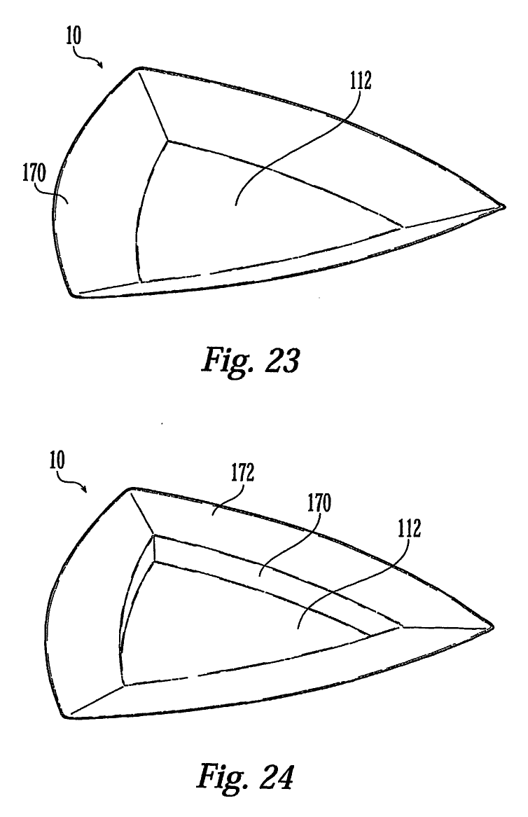

In a preferred embodiment, as illustrated in FIG. 8, edge lines 150 are inscribed into corner regions 130. Edge lines 150 are defined by reference lines 142 (shown in FIG. 7). FIG. 9 shows the preliminary template 100 of FIG. 8 with the material between edge lines 150 removed, forming completed template 160. The removal of material from corner regions 130 thus transforms the remaining material in sidewall region 120 into flaps 165. Flaps 165 are then folded upward along inner arcs 40 so that adjacent edge lines 150 match up with each other. To assist in folding, the material may be scored beforehand. The material along edge lines 150 is then joined to form sidewalls 170 of completed object 10, with base region 110 forming base 112, as shown in FIGS. 10, 11, and 23. It should be noted that sidewalls 170 are thus preferably substantially flat surfaces that may be disposed preferably at an angle θ greater than 0° and less than or equal to about 90° to base 112. Alternatively, by removing additional material from corner region 130, sidewalls 170 may be disposed at an angle θ greater than 90° to base 112.

Object 10 may be used as a charger, a plate, or a bowl, depending upon the shape of the object and the material used. It will be appreciated that the height of sidewalls 170 may be changed by using inner arcs 40 and outer arcs 20 of varying sizes.

Edge lines 150 may physically be joined in any number of ways, depending upon the material used to create object 10. For example, if cardboard is used, adhesive or tape may be used. If ceramic, metal or plastic is used, edge lines 140 may be welded or fused together. Alternatively, it should be noted that edge lines 150 need not be physically joined, for example, where material such as ceramics, metals, and plastics are used that are capable of being deformed and of holding their shape.

It can be appreciated that the completed object 10 has surfaces (i.e., base region 110 and sidewalls 170) that are curved in response to the tensions created by the folding of template 160 along inner arcs 42. This is one aspect of the “folded look” that is achieved by forming objects by this method, in contrast to merely molding such items. Another aspect of this folded look is the relatively sharp delineation that is created between sidewalls 170 and base 112 formed by the folding of the material along inner arcs 40.

Many different variations in the form of object 10 may be created using the method described above. For example, the proportions between base 112 and side walls 170 may be changed by increasing or decreasing the difference between radius of curvature R and radius of curvature T.

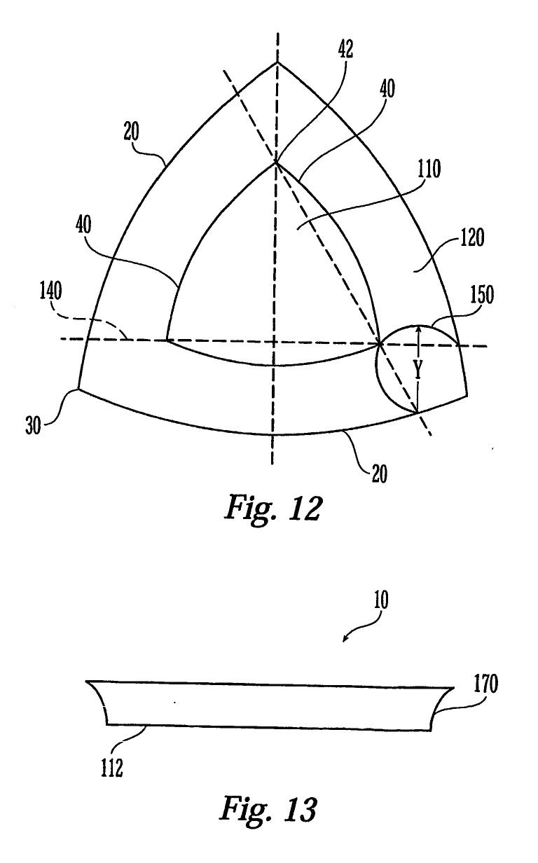

One major variable in the form of object 10 lies in the geometry of edge lines 150. Edges lines 150 will determine the profile, or geometry, of flaps 165 and sidewalls 170. For example, in another preferred embodiment as illustrated in FIGS. 12 and 13, edge lines 150 are formed as arcs with radius of curvature Y and having their centers at the vertex formed where reference lines 40 intersect outer arcs 20. When flaps 165 are folded along inner arcs 40 and edge lines 150 are joined together, object 10 is formed with sidewalls 170 that are concavely curved in response to the curvature of edge lines 150 (see FIG. 13).

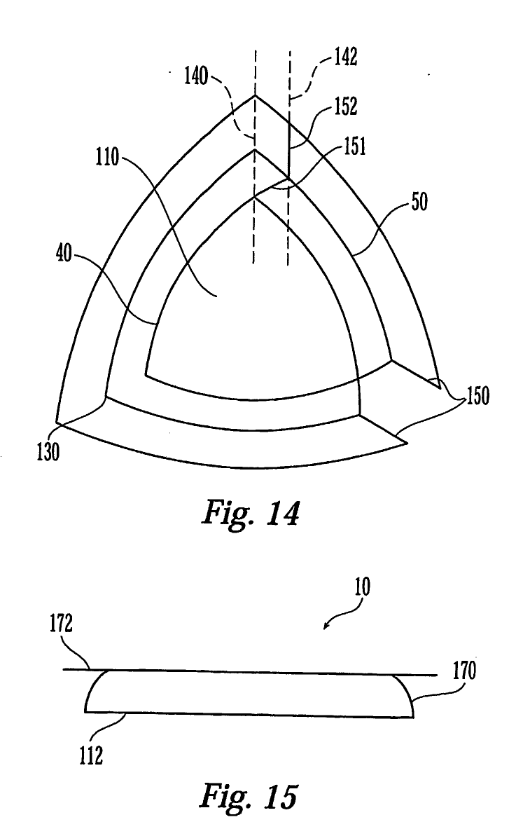

It can be readily seen by those skilled in the art that edge lines 150 may be formed in any number of ways to influence the profile of sidewalls 170. This, in combination with additional geometric information added to sidewall regions 130, provides for a wide variety of sidewall profiles to be formed. As an example, another embodiment of the present invention is shown in FIGS. 14, 15 and 24. Edge lines 150 are inscribed on the template of FIG. 5. Edge lines 150 are formed by the combination of arc 151 and line 152, the endpoints of which are joined along third arcs 50. Arc 151 is defined by a continuation of inner arc 40, and line 152 is defined by reference line 142 that is parallel to reference line 140, which may be easily created using basic geometrical principles that are well known in the art. Removing material from corner regions 130 along edge lines 150, folding the template along inner arcs 40 and third arcs 50, and joining edge lines 150 together forms object 10 having a sidewall with lip 172.

It is to be noted that in all the embodiments of the invention described above, all of the geometric information added to template 100, be it reference lines 140, edge lines 150, or other geometric information added to sidewall regions 130, originate from vertices 30, 42. As geometric information is added to template, additional reference points are created. The use of reference points and lines to define the geometric information that is added to template 100 provides a structured and repeatable method of creating three-dimensional objects from flat pieces of material using simple tools.

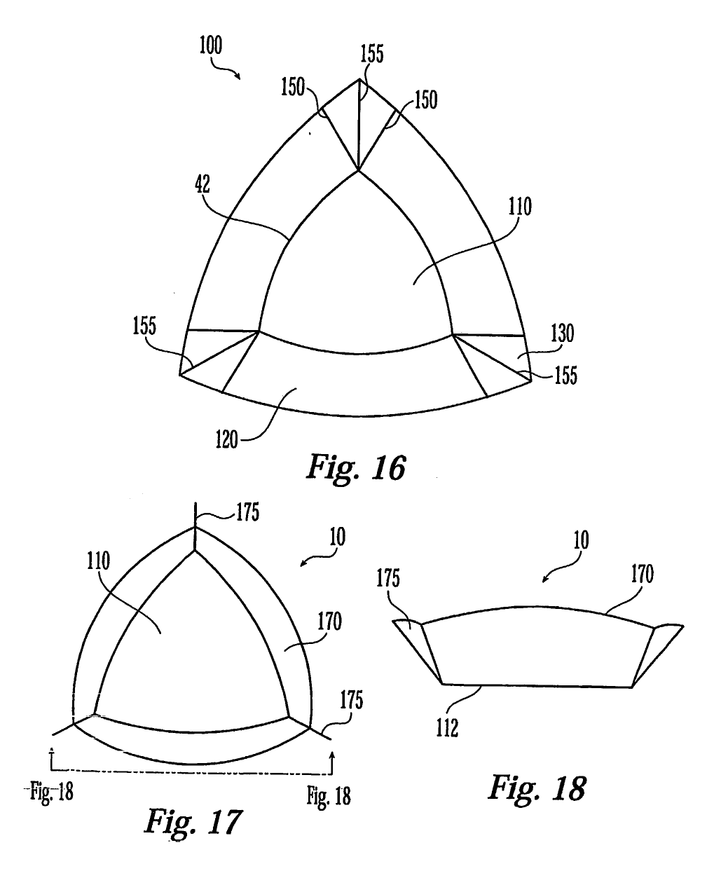

As discussed above, once edge lines 150 are formed, the manipulation of corner regions 130 may also occur through the folding of material within corner regions 130 upon itself, in lieu of removing material. This method may create additional ornamental elements at the corners of object 100. For example, template 100 as illustrated in FIG. 16 has the same edge lines as template 100 of FIG. 7. However, instead of removing the material between edge lines 150 to form template 160 of FIG. 9, a fold line 155 is added to the material within each corner region 130. The material of template 100 is then folded along inner arcs 42, edge lines 150 and fold lines 155 to form the object illustrated in FIGS. 17 and 18. It can be seen that the material in corner regions 130 has been used to form projections 175 at the corners of object 10. If desired, projections 175 may then be further manipulated to modify the aesthetic appearance of object 10. For example, projection 175 in alternative embodiments may be farther shaped or even completely removed. Alternatively, additional fold lines 155 may be added to template 100 prior to folding and joining of edge lines 150 It is to be appreciated that many other variations of folds may be used that are within the scope of the present invention.

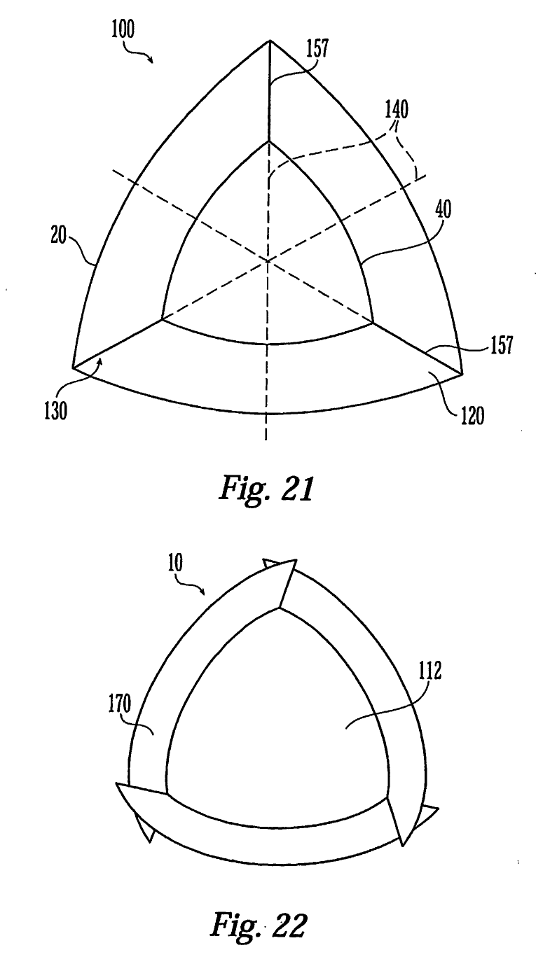

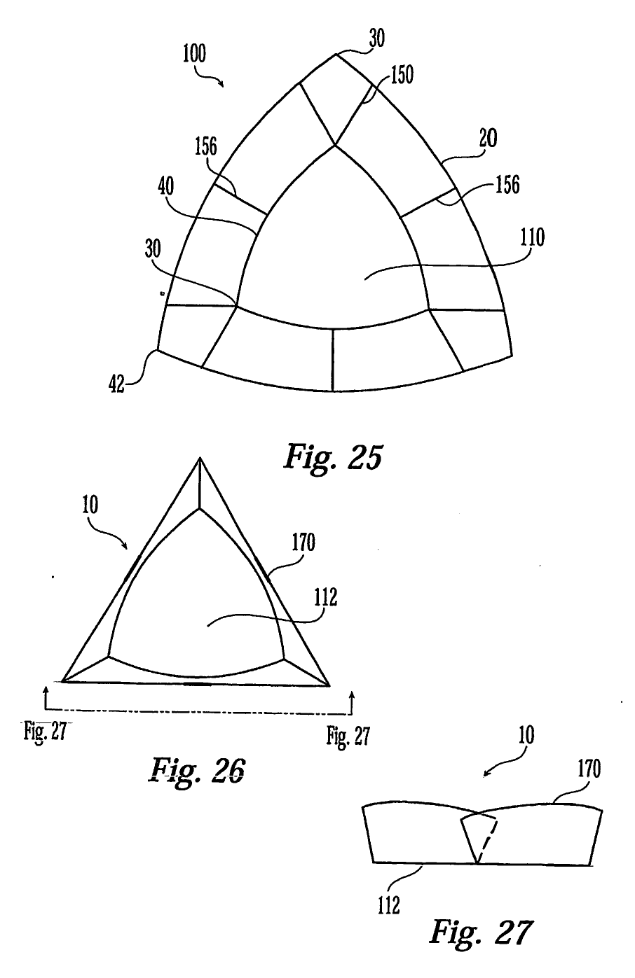

Another method of manipulating the material in corner regions 120 comprises cutting the material and overlapping it with other material in template 100. For example, FIGS. 21 illustrates template 100 to which a cut line 157 has been added to each corner region. Cut lines 156 are defined by reference lines 140. When template 100 is folded along inner arcs 40, the material in corner regions 120 may be overlapped and joined, resulting in the object illustrated in FIG. 22. A different type of ornamentation is thus possible. One skilled in the art can readily appreciate that the different types of manipulation described here may be combined in any number of ways to create additional resulting profiles for sidewalls 170 and/or shapes for object 10. In addition, edge lines 150, fold lines 155, and cut lines 156 may be inscribed on other portions of sidewall region 120 other than corner 130 to allow for even more variety in the manipulation of sidewall region 120. For example, as shown in FIG. 25, template 100 has edge lines 150 inscribed in corner regions 130 and cut lines 156 inscribed in sidewall regions 120 outside of corner regions 130. The material of sidewall region 120 may then be cut along edge lines 150 and cut lines 156 and folded along inner arcs 40 such that adjacent edge lines 150 may be joined and the material adjacent to cut lines 156 may be overlapped to form object 10 as illustrated in FIGS. 26 and 27.

The steps of a method in accordance with the present invention may be performed in a different order than the order described above without departing from the spirit and scope of the invention. For example, template 100 as illustrated in FIG. 8 may be formed by first inscribing inner arcs 40 with inner vertices 42, then using inner vertices 42 as reference points to form outer arcs 20, reference lines 140, and edge lines 150.

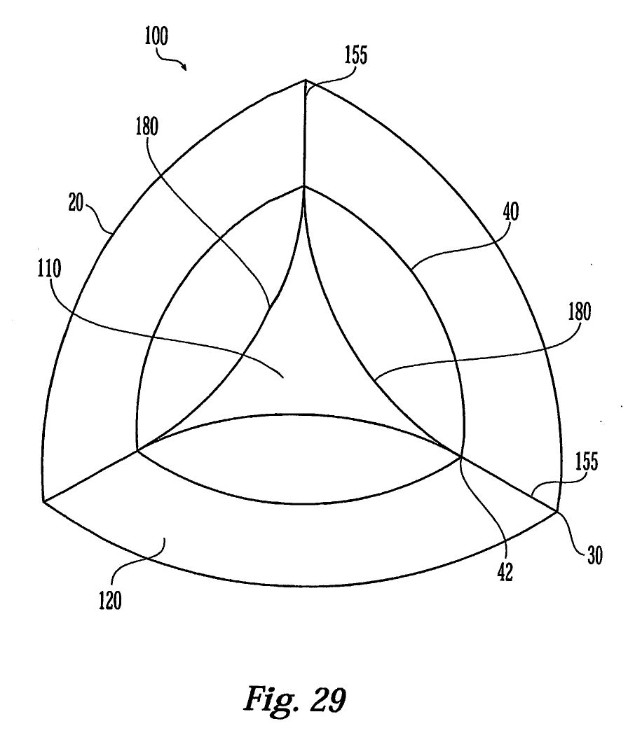

As can be seen from the embodiment discussed above, both non-Euclidean and Euclidean geometrical concepts may be combined using the method of the present invention to produce a multitude of shapes. It is to be understood that in addition to the straight lines and exploded arcs illustrated above, other types of arcs and lines defined by mathematical functions maybe used to add geometric information to template 100. For example, in addition to circular exploding arcs, imploding circular arcs and parabolic arcs may also be used. For example, FIG. 29 illustrates template 100 having imploded arcs 180 inscribed within base region 110 and fold lines 155 inscribed in sidewall region 120. As discussed above, geometric information may be inscribed onto the material in a variety of different orders. Thus, template 100 may be formed by first inscribing inner arcs 40, then fold lines 155, followed by outer arcs 20 and imploded arcs 180. Template 100 may then be folded along fold lines 155, inner arcs 40, and imploded arcs 180 to form a three-dimensional object.

FIG. 20 illustrates different edge lines 150, defined by mathematical functions, that may be added to template 100 to create a variety of profiles for sidewalls 170.

The methods described above for creating a three dimensional object may also be used to create molds that in turn are used to transfer the aesthetic characteristics of the object to another object. For example, object 10 may be used as a mold to which clay is applied. The clay, after taking on the form of object 10, may then be fired in a kiln to create a plate, bowl, cup, or other similar object with the folded look of object 10. In another example, object 10 may be pressed into a ductile material to form an impression in the material with the shape and aesthetic appearance of object 10.

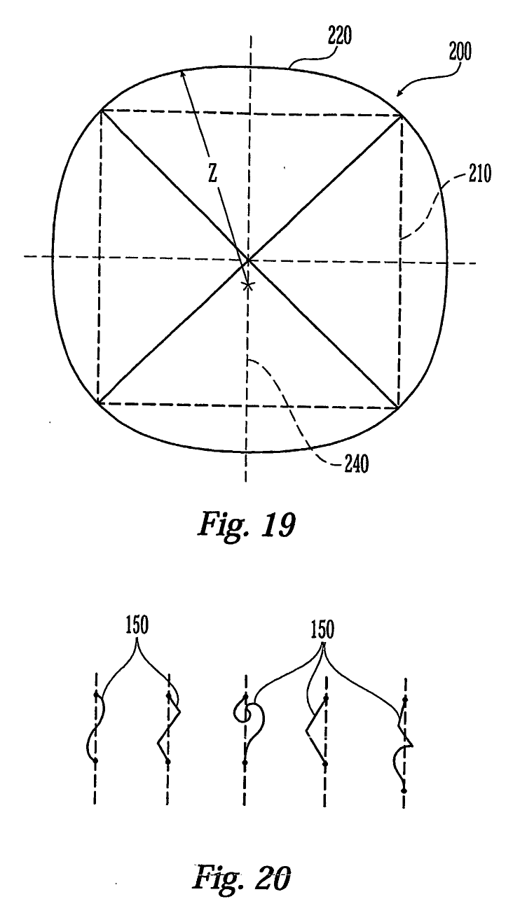

The method described above may be used with basic geometric patterns other than triangles. For example, as shown in FIG. 19, perimeter reference lines 210 define a square that is the basic geometric shape from which template 200 is formed. Reference lines 240 define reference points on which the centers of arcs 220 (with radii of curvature Z) may be located, forming the non-Euclidean square of template 200. It can be appreciate that other basic geometric shapes, such as pentagons or hexagons, may also be used.

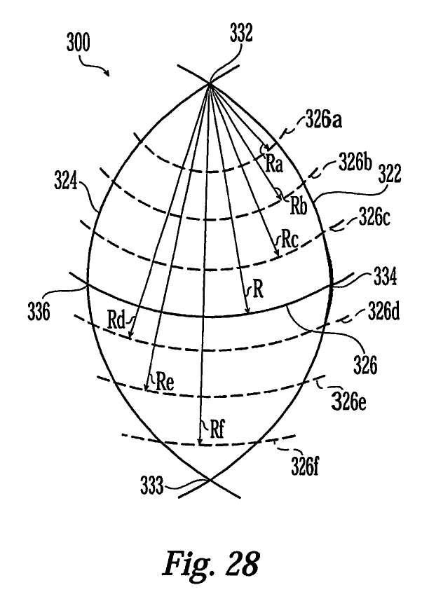

The present invention may also be used to create templates with sides that are not of equal length. For example, FIG. 28 shows template 300 formed from first arc 322 and second arc 324 that intersect at first vertex 332 and second vertex 333. With additional reference to FIG. 3, first arc 322 and second arc 324 may be formed by extending first outer arc 22 and second outer arc 24, both having radius of curvature R so that they intersect at both first vertex 332 and second vertex 333, as shown. Third arc 326 may be inscribed onto template 100 in the same manner as third outer arc 26, having radius of curvature R also to produce the template shown in FIG. 3. However, as illustrated by arcs 326a-326f, the third arc may also be inscribed so that its radius of curvature is less than or greater than the radius of curvature R of first circular arc 322 or second circular arc 324, as shown by radii Ra-Rf. Accordingly, templates and three-dimensional objects derived therefrom, having radii Rd-Rf greater than R will be generally oblong in length. Conversely, templates and three-dimensional objects derived therefrom with arcs 326a-326c having radii Ra-Rc less than R will be generally oblong in width. Template 300 may thus describe a non-Euclidean triangle with sides of unequal length. Inner arcs may then be inscribed in the same manner described above to form sidewall regions for template 300. It can be readily seen by those skilled in the art that other shapes with unequal sides may also be used with the present invention. Furthermore, the present invention may also be used to create non-symmetrical objects using the methods described herein.

It can be readily seen by those skilled in the art that a method in accordance with the present invention and the resulting objects may take many different configurations in addition to the ones presented here while remaining within the spirit and scope of the present invention. Accordingly, it should be clearly understood that the embodiments of the invention described above are not intended as limitations on the scope of the invention, which is defined only by the following claims.

What is claimed:

1. A method of preparing a template capable of forming a three-dimensional object from two-dimensional material, comprising the steps of:
inscribing a first outer arc on a surface of the material, the first outer arc having a first radius of curvature and a first endpoint;
inscribing a second outer arc, the second outer arc having a radius of curvature equal to the first radius of curvature, wherein the center of the second outer arc is at the first endpoint, and the second outer arc intersects the first outer arc to form a first outer vertex;
inscribing a third outer arc having a third radius of curvature equal to the first radius of curvature and having its center at the first vertex, wherein the third outer arc intersects the first outer arc and the second outer arc to form a second outer vertex and a third outer vertex;
inscribing three inner arcs, the inner arcs each having a radius of curvature equal to each other but less than the first radius, wherein each of the three inner arcs intersect with each other to form first, second, and third inner vertices; and
separating the material inscribed by the first, second, and third outer arcs to form a template.

2. The method of claim 1, wherein each of the inner arcs is parallel to at least one of the first, second, or third outer arcs.

3. The method of claim 1, wherein the material between the outer arcs and the inner arcs defines a sidewall region, an area of the sidewall region near each of the outer vertices further defining corner regions, and wherein the material enclosed within the inner arcs defines a base region.

4. The method of claim 3, further comprising the step of manipulating the material of the template within the sidewall region, and folding the sidewall region material along at least one of the first, second or third inner arcs to form a three-dimensional object

5. The method of claim 4, wherein the step of manipulating the material further comprises removing material from at least one of the corner regions of the template.

6. The method of claim 5, further comprising the step of inscribing edge lines into the material of at least one of the corner regions to define the material that is to be removed from the template.

7. The method of claim 6, wherein the sidewall region material along at least two of the first, second, and third inner arcs are folded, and further comprising the step of joining adjacent edge lines together after the material has been folded.

8. The method of claim 1, further comprising the step of scoring the material along the first, second, and third inner arcs to facilitate folding the material to form a three-dimensional object.

9. The method of claim 1, further comprising the steps of inscribing additional arcs located between the outer arcs and the inner arcs.

10. The method of claim 4, wherein the step of manipulating the material further comprises folding the material of at least one of the corner regions of the template.

11. The method of claim 10, further comprising the step of inscribing edge lines and fold lines into the material of at least one of the corner regions of the template to define how the material is to be folded.

12. The method of claim 4, wherein the step of manipulating the material further comprises cutting the material of at least one of the corner regions of the template.

13. A three-dimensional object produced according to the process of claim 4.

14. The method of claim 4, further comprising folding the material along each of the first, second, and third inner arcs in an upward direction relative to the base region to create a three-dimensional object.

15. A method of forming a three-dimensional object from a piece of two-dimensional material comprising the steps of:
inscribing an outer perimeter on a surface of the material comprising at least three intersecting outer arcs, the outer arcs defining an interior, the at least three outer arcs curving outwardly from the interior;
inscribing a inner perimeter within the outer perimeter, the inner perimeter defining a base region therein, and the outer perimeter and the inner perimeter defining at least three sidewall regions therebetween;
adding additional geometric information to the sidewall region; and
manipulating the sidewall region to form a three-dimensional object with a plurality of sidewalls.

16. The method of claim 15, wherein the step of adding additional geometric information further comprises the steps of:
adding reference indicators to the surface of the material;
using the reference indicators to define a plurality of reference points; and
using the plurality of reference points to inscribe additional lines into the material.

17. The method of claim 16, wherein the additional lines are inscribed into the sidewall region of the template.

18. The method of claim 15, wherein the outer perimeter is an exploded non-Euclidean triangle.

19. The method of claim 18, wherein the inner perimeter is an exploded non-Euclidean triangle that is parallel to the outer perimeter.

20. The method of claim 15, wherein the outer perimeter is an exploded non-Euclidean polygon.

21. A three-dimensional object comprising a base and a plurality of sidewalls, wherein the object is formed by a method comprising the steps of:
inscribing a first arc on a surface of a two-dimensional material, the first arc having a first radius of curvature and a first endpoint;
inscribing a second arc, the second arc having a radius of curvature equal to the first radius of curvature, wherein the center of the second arc is at the first endpoint, and the second arc intersects the first arc to form a first outer vertex;
inscribing a third arc having a third radius of curvature equal to the first radius of curvature and having its center at the first vertex, wherein the third arc intersects the first arc and the second arc to form a second outer vertex and a third outer vertex;
inscribing three inner arcs, the inner arcs each having a radius of curvature equal to each other but less than the first radius, wherein each of the three inner arcs intersect with each other to form first, second, and third inner vertices;
separating the material inscribed by the first, second, and third outer arcs to form a template; and
manipulating the material of the template within the sidewall region, and folding the material along at least one of the first, second or third inner arcs to form a three-dimensional object.

22. A non-Euclidean three-dimensional object suitable for use as a plate or bowl comprising:
a substantially flat base defining a base plane and comprising three outwardly curving base arcs, the base arcs intersecting each other to form three base vertices;
three substantially flat sidewalls attached to the base, each sidewall projecting upwardly at an angle to the base plane, each sidewall comprising at least one outwardly curving sidewall arc to form a top sidewall edge, each sidewall arc being spaced apart from and parallel to at least one of the base arcs; and
three corner edges connecting the sidewalls, each corner edge originating at the base vertices and projecting upwardly at an angle to the base plane, the sidewalls being joined together to each other at the corner edges, whereby the base and sidewalls form a three-dimensional plate or bowl capable of holding food.

23. An object according to claim 22, wherein an angle is formed between the base and the sidewalls that is greater than 0° and less than or equal to 90°.
